(19) United States
(12) Patent Application Publication
(10) Pub. No.: US 2014/0273184 A1
(43) Pub. Date: Sep. 18, 2014

(54) ELECTROKINETIC DEVICES AND METHODS FOR CAPTURING ASSAYABLE AGENTS

(71) Applicant: INSPIROTEC LLC, Chicago, IL (US)

(72) Inventor: Julian Gordon, Lake Bluff, IL (US)

(73) Assignee: Inspirotec LLC, Chicago, IL (US)

(21) Appl. No.: 13/804,050

(22) Filed: Mar. 14, 2013

(51) Int. Cl. G01N 1/40; B03C 3/40

(52) U.S. Cl. CPC G01N 1/40; B03C 3/40
USPC 435/287.2; 422/69; 435/288.7; 96/80

(57) ABSTRACT

Electrokinetic devices and methods are described with the purpose of collecting assayable agents from a dielectric fluid medium. Electrokinetic flow may be induced by the use of plasma generation at high voltage electrodes and consequent transport of charged particles in an electric voltage gradient. Pulsed DC fields applied to electrodes result in enhanced flow by synchronizing the pulses between successive electrodes. The agents are directed by creation of an electrokinetic potential well, which will effect their capture on to an assay device.

### CROSS-REFERENCE TO RELATED APPLICATIONS

There are no related applications.

### FEDERALLY SPONSORED RESEARCH OR DEVELOPMENT

Not Applicable.

### MICROFICHE/COPYRIGHT REFERENCE

Not Applicable.

### FIELD OF THE INVENTION

The field of the present invention is air sampling devices and testing. It includes electrokinetic methods for propulsion of charged particles. The present invention relates to the collection of and sampling of assayable agents in a dielectric medium. This includes, but is not limited to, sampling air for agents whose presence or absence is determinable by bio-specific assays.

### BACKGROUND OF THE INVENTION

Prior art for air sampling and testing has been extensively summarized in U.S. Pat. No. 8,038,944. Further prior art devices for numerous applications are listed in Table 1, below.

TABLE 1
Examples of air sampling devices.

| | | Sampling rate | |
|---|---|---|---|
| Manufacturer | Device | (Liters/minute) | Comments |
| Bertin | Coriolis μ | 100-300 | Particle size >0.5 micron. Volume |
| | | | 10-15 ml. Cleanroom application. |
| | | | Pollens, moulds, bacteria, viruses |
| | | | (Amiens Hospital, RSV and |
| | | | rotavirus, no authors), latex |
| | | | allergen |
| | Coriolois FR | 100-300 | First responders. Pathogens |
| | | | (anthrax, ricin, botulinum toxin). |
| | | | 0.5-10 micron. 15 ml. |
| | Coriolis | 600 | Bio-surveillance. 0.5-10 micron |
| | Recon | | range. 20 ml sample volume. Up |
| | | | to 15 min collection time. |
| | Coriolis | 100-300 | Allergens. Pollen grains, fungi |
| | Delta | | spores. Up to 6 hrs of collection. |
| | | | Windvane direction. 10-15 ml |
| | | | sample. |
| Innovatek | BioGuardian | 1000 | 1-10 micron particles. 10-15 ml |
| | | | sample. Wet-walled multi-cyclone |
| | | | inner collector (U.S. Pat. No. |
| | | | 6,468,330) |
| | | | Unique outer centrifuge/impactor |
| | | | to reduce system interference |
| | | | from large particles (patent |
| | | | pending). Data with B. subtilis. |
| | No name. | | Electrostatic precipitation for sizing |
| | “Proprietary” | | fibers in the air. “Swiss company” |
| FLIR Systems | AirSentinel | 40 | No information |
| | C100 | 150 | Small particles, single spores 1-10 |
| | | | microns. Rotating impactor |
| | | | technology. 6 ml sample size |
| | IBAC | 3.8 | Rotating impactor technology; |
| | | | >0.7 microns., but claims for |
| | | | viruses. 6 ml sample size |
| | BioBadge | 40 | 1-10 microns. Handheld. Anthrax, |
| | | | plague. Collects on disk. |
| | BioCapture | 200 | 0.5-10 micron. Claims spores, |
| | | | bacteria, viruses, toxins like ricin. |
| | | | 2-5 mL sample. Up to 60 min |
| | | | sampling time |
| | BioXc | 150 | 1-10 micron capture. Patented |
| | 200GX | | rotating impactor technology. |
| | | | Sample directly into GeneExpert |
| | | | Cartridge. Reduced risk of re- |
| | | | aerosolizaton. |
| Dycor | XMX/2L-MIL | 530 | 1-10 micron samples. 5 ml |
| | | | volume. Dry filter option. Capturing |
| | | | and maintaining viability of viral |
| | | | and bacterial particles in human |
| | | | and animal disease outbreaks |
| | XMX/102 | 530 | Batch operation. Up to 102 |
| | | | samples into vacutainers, 10 sec |
| | | | to 10 min per sample. 10 ml |
| | | | starting volume. |
| | XMX/CV | 530 | Civilian version of CM. Same |
| | | | specs |
| | CSU-1 | 10 | Continuous sampling unit. Dry |
| | | | filter. 12 hours operation on |
| | | | battery. No other info. |
| Thermo | ASAP 2800 | 200 | Small, quiet (55DB). 1-10 micron. |
| | | | Particle collection technology |
| | | | patented by Harvard School of |
| | | | Public Health. High velocity |
| | | | stream impacted on to |
| | | | polyurethane foam. 8 strips on a |
| | | | spool allow interval collection. |
| | | | Lovelace Respiratory Research |
| | | | Institute has written a standard |
| | | | operating procedure for the |
| | | | extraction of particles. No volume |
| | | | info. |
| Innovaprep | SpinCon | 450 | Down to 0.2 micron. High velocity |
| | | | airflow impacts finite liquid volume. |
| | | | 10 ml sample. Up to 6 hrs runs. |
| | | | Anthrax, foot and mouth, citrus |
| | | | canker, avian influenza, mold. |
| | Omni 3000 | 300 | Same Spincon technology. |
| | | | Sample <9 ml. Water for |
| | | | evaporative makeup. |
| | ACD-200 | 200 | 52 mm dry electret filter. Electret |
| | Bobcat | | filter to attract particles. 1-10 |
| | | | micron. Run up to 18 hrs. Rapid |
| | | | filter elution system. 6-7 ml liquid |
| | | | sample. |
| Research | SASS 2300 | 325 | Multi-stage wet-wall aerosol |
| International | | | collection method, maintains |
| | | | constant. Newcastle disease, |
| | | | hoof-and-mouth disease, avian flu |
| | | | virus. Long sampling operation. 1-10 |
| | | | micron sample. 4-5 ml sample. |
| | SASS 2400 | 40 | Same as 2300, lower volume. |
| | | | Newcastle disease, hoof-and- |
| | | | mouth disease, avian flu virus. 1 ml |
| | | | sample. 7 days operation. |
| | SASS 3100 | 150-350 | Dry electret filter. 44 mm disk. 0.3 |
| | | | to 0.5 micron particles can be |
| | | | captured. SASS 3010 extracts into |
| | | | 5 ml. |
| | SASS 4000 | 3600 | Pre-concentration with rectangular |
| | | | collector blades. Feeds at 30-325 |
| | | | LPM into a secondary system with |
| | | | electret as an alternative option. 72 |
| | | | DB sound level. |
| | SASS 4100 | 3600 | High capacity system. Like 4000 |
| | | | but with electret filter. 43.4 mm |
| | | | O.D. × 3 mm thick micro-fibrous |
| | | | filter |
| Center for | NIOSH | 3.5 | Samples collected by impact in 2 |
| Diseases | | | stages followed by filter. Collects |
| Control | | | in 1 ml. Influenza virus, pollen, |
| | | | mold |

The table summarizes key features of devices so far as can be obtained from the respective companies web sites. Important features are volume flow and sample volume. The ratio between these, defined as the concentration ratio, determines the ultimate detection limits. All of the devices depend on a pump, and the pump usually has to work against back-pressure created by forcing through a small pore size filter, or through fine jets to create an impact on a surface for collection. The requirement for a pump has the disadvantage of high power consumption and generation of noise. Thus, there is a need for devices with a high concentration ratio, low power requirement and ability to run unobtrusively in any location. Some use electret filters with permanent electrostatic charge pairs which attract charged particles, but these also do not use electrical potentials applied to electrodes to direct the flow. They also do not impart charge to uncharged material.

Several of the devices in Table 1 have battery operation and a degree of portability, but are still relative large, cumbersome and power-hungry.

There exist numerous commercially available systems for air purification based on filtration or electrostatic precipitation. For a general description see the Environmental Protection Agency article “Guide to Air Cleaners in the Home”, U.S. EPA/OAR/ORIA/lndoor Environments Division (MC-6609J) EPA 402-F-08-004, May 2008. The company 3M commercializes an electret-based air filtration medium under the Filtrete™. Numerous commercial examples of systems exist using either High Efficiency Particulate Air (HEPA) filters or electrostatic precipitation filters. Such systems are widely used for removal of particulate matter or allergens from air, including as part of domestic heating, ventilation and air conditioning (HVAC) systems. HEPA filters have the advantage of removal of particles down to the micron size range, whereas electrostatic precipitation methods have the advantage of entailing high volume flow with little or no pressure differential. See by Bourgeois, U.S. Pat. No. 3,191,362 as a detailed example for the technical specification of an electrostatic precipitation system. While efficiently removing agents from the air, such air purification systems do not lend themselves to collection of samples for analysis.

Electrokinetic devices are useful for providing low power consumption and silent air purification devices. The original electrokinetic principle was enunciated by Brown in U.S. Pat. No. 2,949,550. This was further improved by Lee in U.S. Pat. No. 4,789,801 for improving airflow and minimizing ozone generation. Further improvements for the commercially available system are described in by Taylor and Lee, U.S. Pat. No. 6,958,134; Reeves et al, U.S. Pat. No. 7,056,370; Botvinnik, U.S. Pat. No. 7,077,890; Lau et al, U.S. Pat. No. 7,097,695; Taylor et al, U.S. Pat. No. 7,311,762. In the foregoing descriptions of devices using electrokinetic propulsion, a common element is a high voltage electrode consisting of wires or sharp points. A very steep voltage gradient is generated orthogonally to the wire because of the very small cross-sectional area of the wire, and similarly in the neighborhood of a sharp point. The high voltage gradient causes the creation of plasma consisting of charged particles. Similarly, St. Elmo's fire is a weather phenomenon in which luminous plasma is created by a coronal discharge from a sharp or pointed object in a strong electric field in the atmosphere, and was observed historically on ships masts or rigging. In the cleaning devices, kinetic energy is imparted to the charged particles by the high voltage gradient. The resulting net air flow is created by exchange of kinetic energy between charged and uncharged particles, and the net air flow is directed by the juxtaposition of planar electrodes which are at zero or opposite sign voltage to that of the wire electrode. Charged particles are electrostatically precipitated on to the planar electrodes, which may periodically be removed for cleaning. A variety of electrokinetic-based air cleaning systems are now commercialized, for example by Envion (Van Nuys, Calif.), Heaven Fresh (Waukesha Wis.) and Sharper Image (Tokyo, Japan). Table 2 lists the air flow performance of some of these devices so that comparison can be made with the collection devices of Table 1

TABLE 2
Air flow with current electro-kinetic air cleaning devices.

| | | Flow |
|---|---|---|
| Source | Model | (liters/min) |
| Sharper Image | Quadra | 790 |
| | Tabletop | 360 |
| | Small spaces | 120 |
| Envion | Ionic Pro | 210 |
| Heaven Fresh | HF20 | 59 |
| | HF200 | 108 |

This body of work is directed toward air purification, not sample collection. Prior art on the use of the Sharper image Quadra for air sampling for allergen detection was reviewed in U.S. Pat. No. 8,038,944. In U.S. Pat. No. 8,038,944 was described methodology for electrokinetically driving charged particles created by a high voltage plasma, on to a capture electrodes, and the use of non-conducting materials to intercept the charged particles in such a way that the sample could easily be transferred into a bio-specific assay. However, it has been noted that use of a nonconductive material may result in reduction in air flow. Further, the information in Table 1 shows that air flow is at a premium for maximizing the amount of material that can be collected, and that the ICD is in the lower end of the range of the flow values of the devices listed. Thus, there is a need to increase the flow rate, preferably without use of moving parts.

In addition, the size range of particles collected by the devices listed in Table 1 is limited to more than about 0.5 micron, possibly 0.2 micron. All fall off in efficiency of collection as the particle size decreases. FIG. 1 shows examples of sizes of particle of interest and the range of the current devices is summarized in Table 1. There may be a range of particle sizes in the atmosphere that is presently unknown as it is outside of the range of current samplers (“Aerobiome Incognito”). There is a need to assay particles in this lower size range.

There is thus a need for a device that can sample large volumes of air, but to concentrate into a very small volume for analysis, and to work silently with low energy consumption

### SUMMARY OF THE INVENTION

The present invention encompasses the use of an electrode or electrodes to create a potential well that will draw charged particles out of a flowing dielectric fluid stream and focus them on to the collection means of an assay device. Improvements result from the use of pulsed voltages applied to electrodes that create potential differences varying in time so that transport of ionized particles from one electrode set to the next is enhanced. The voltage changes serve to sample from an initially large aperture with attendant high volume flow, increase the flow velocity, as well as to efficiently capture the particles and enhance sensitivity by means of the focusing effect on the collection means. If not already electrically charged, charge is imparted to the agent to be analyzed by means of a high voltage wire electrode arrangement and consequent plasma generation; the agent is focused on to the collection means of the assay device by the potential well; and finally electrostatically precipitated thereon.

In one aspect of the invention, a device for collection of a sample from a dielectric fluid medium for assay comprises an enclosure. Flow means direct fluid flow of the dielectric fluid medium in the enclosure. One or more wire electrodes in the enclosure subject dielectric fluid medium flowing in the enclosure to an ionizing plasma. Supporting means operatively associated with the enclosure support the bio-specific assay device. One or more capture electrodes are positioned proximate the supporting means to create a voltage potential well whereby charged particles thus generated within the dielectric fluid medium, or pre-existing in said dielectric fluid medium, are propelled into the supported bio-specific assay device thereby electroprecipitating the charged particles on to a sample collection region of the bio-specific assay device.

In a further aspect of the invention, voltage pulses between successive electrodes are synchronized such that the maximum in one set coincides with a minimum in the preceding set, so that any tendency to be attracted to the preceding set is neutralized by the potential attraction to the following set. Specifications for creating pulses are described in the prior art, as in the Ionic Breeze patent estate. A secondary circuit senses the sum of the voltages between successive sets of electrodes. This secondary set voltage feeds into the pulse generating circuit of the second pulse generator, and regulates the phase of the pulses such that the secondary voltage is zero. This ensures that the pulses between the successive electrodes are 180° out of phase.

In a still further aspect of the invention, successive sets of electrodes are of progressively smaller dimensions resulting in a progressive focusing effect and progressive enhancement of the flow velocity. A further aspect of the current invention is the ability to transmit a voltage across a non-conducting material if the high voltage is supplied as pulses, rather than constant DC. This gives greater freedom in the design of simpler means for covering a removable capture electrode with a non-conductive material which will not interfere with the transmission of the pulsed voltage.

Other objects, features, and advantages of the invention will become apparent from a review of the entire specification, including the appended claims and drawings.

### BRIEF DESCRIPTION OF THE DRAWINGS

FIG. 1 is a schematic showing particle size ranges of various targets of interest relative to the range captured by standard samplers;

FIGS. 2A-2F are a representation of a device with one set of plate electrodes tapering toward a capture electrode;

FIGS. 3A-D are a representation of a device with multiple sets of electrodes, each tapering toward the next set, and finally toward a capture electrode;

FIGS. 4A-D are a representation of a device with multiple sets of electrodes, each tapering toward the next set, and finally toward a capture electrode, where each set is rotated at 90° with respect to the preceding set;

FIGS. 5A-C are a representation of a device where the high voltage plasma-generating electrode takes the form of a mesh of wires rather than a single wire, and subsequent electrodes take the form of succession of truncated cones of successively smaller dimensions;

FIG. 6 is a block diagram of a control circuit for the device of FIG. 5, showing the control elements that control the voltage difference between each successive set of electrodes, all under the control of a master-controller;

FIG. 7 illustrates the waveforms of the successive voltage pulses between successive sets of electrodes as in FIG. 6;

FIG. 8 illustrates an alternative square waveform of the pulses, otherwise as in FIG. 7;

FIG. 9 illustrates the waveforms where the pulses comprise sub-pulses at a higher frequency than the major pulses; and

FIG. 10 is the design of a non-conducting material that may envelope a removable capture electrode.

### DETAILED DESCRIPTION OF THE INVENTION

This application describes an electrokinetic device used for air sampling and testing. It uses electrokinetic methods for propulsion of charged particles. The device is used for collection of and sampling of assayable agents in a dielectric medium. This includes, but is not limited to, sampling air for agents whose presence or absence is determinable by bio-specific assays. The field includes sampling of air for biological agents, direction to, and deposition on, a collection means for an assay device. The agent-specific assays may include immunoassays, nucleic acid hybridization assays, or any other assays entailing ligand—antiligand interactions. Assays may include, but are not limited to, detection means which are colorometric, fluorescent, turbidimetric, electrochemical or voltammetric. Agents assayed include,

TABLE 3
Potential airborne pathogens.

| Viruses | Bacteria | Fungi |
|---|---|---|
| Adenovirus | Acinetobacter | Absidia |
| Arenavirus | Actinomyces | Acremonium |
| Coronavirus | Alkaligenes | Alternaria |
| Coxsackievirus | Bacillus | Aspergillus |
| Echovirus | Bordetella | Aureobasidium |
| Filovirus | Cardiobacterium | Blastomyces |
| Hantavirus | Chlamydia | Botrytis |
| Monkeypox | Clostridium | Candida |
| Morbillivirus | Corynebacteria | Chaetomium |
| Norovirus | Coxiella | Cladosporium |
| Orthomyxovirus | Enterobacter | Coccidioides |
| Parainfluenza | Enterococcus | Cryptococcus |
| Paramyxovirus | Francisella | Emericella |
| Parvovirus B19 | Haemophilus | Epicoccum |
| Poxvirus | Klebsiella | Eurotium |
| Reovirus | Legionella | Exophiala |
| Respiratory Syncytial | Micromonospora | Fusarium |
| Virus | | |
| Rhinovirus | Micropolyspora | Geomyces |
| Togavirus | Moraxella | Helminthosporium |
| Varicella | Mycobacterium | Histoplasma |
| | Mycoplasma | Mucor |
| | Neisseria | Oidiodendron |
| | Nocardia | Paecilomyces |
| | Pseudomonas | Paracoccidioides |
| | Saccharomonospora | Penicillium |
| | Serratia | Phialaphora |
| | Staphylococcus | Phoma |
| | Streptococcus | Pneumocystis |
| | Thermoactinomyces | Rhizomucor |
| | Thermomonospora | Rhizopus |
| | Yersinia | Rhodoturula |
| | | Scopulariopsis |
| | | Sporothrix |
| | | Stachybotris |
| | | Trichoderma |
| | | Ulocladium |
| | | Wallemia |

but are not limited to, bio-warfare agents, pathogens, allergens, toxins or pollutants. Possible pathogens are listed in Table 3. Allergens may include those derived from domestic animals, household pets, mites, insects such as cockroaches. Toxins include such as ricin, botulinus toxin, or bacterial endotoxin. Further dielectric media may include sampling of dielectric fluid medium such as oil for the food industry, or petrochemical and industrial oil.

The device is used to practice methods for accelerating charged particles in electric fields. The device utilizes electric fields which have frequency matched to the velocity of the charged particle, and acceleration takes place by increasing the frequency between successive electrode pairs. Further acceleration takes place by using the field to confine the particles to ever-decreasing volumes by successive reduction of the size of the electrodes. Increase in flow will also take place by the Venturi effect, which will have the effect of sucking in larger volumes of air via the interstices between the electrodes. One advantage of the high velocity of the particles is that they will stick more effectively on the final capture material.

From the underlying physics, the methodology of the current invention is indefinitely scalable, and so can be constructed to analyze very large volumes of fluid. Further, the scaled-up version can be used to create a very simple wind-tunnel. This is both easier to construct than a conventional wind tunnel, having no moving parts, and there will also not be any necessity to compensate for the rotation of the air mass due to the rotation of a fan.

A further aspect of the present invention is the use of the fact that the force on particles in an electric field is proportional to the field gradient and the particle charge. The effect is thus relatively independent of mass. Prior art sampler methods depend on particle mass for their effect. The present invention thus has the capability of sampling in the region referred to as Aerobiome Incognito in FIG. 1.

The included figures show in detail specific electrode arrangements which illustrate various embodiments of the invention. In its simplest form, the design consists of a wire electrode, a pair of plate electrodes and a capture electrode. The advantages of this geometry may be enhanced by the synchrony and amplitudes of the voltages applied between a wire electrode and the plate electrodes, and the plate electrodes and the capture electrode.

Each of FIGS. 2-4 consists of parts A, B, C and D where A, B and C are viewed along the x, y and z axes, respectively, and D is a perspective view. Further, FIGS. 2E and 2F show a perspective view of an exemplary device within a housing. FIG. 5 includes parts A and B along the x and z axes, with D being a perspective view. The y axis would be the same view as the x axis.

FIGS. 2A-D show an electrokinetic device 200 for capturing particulates from the air in accordance with a first embodiment of the invention. The device 200 includes a housing 205 enclosing a pair of trapezoidal electrodes, 201 and 202, a capture electrode in the form of a small plate, 203, and the wire electrode 204, where the plasma is generated. FIG. 2E illustrates the device 200 from the perspective of the inlet end with electrodes 201 and 202 and wire electrode visible. FIG. 2F illustrates the device 200 from the perspective of the outlet end with the capture electrode 203 visible.

The device 200 in its most basic form may operate similar to the devices described and illustrated in our U.S. Pat. No. 8,038,944, the specification of which is hereby incorporated by reference herein. As described with respect to the embodiments therein, a constant DC voltage was applied to the various electrodes. As described herein, a pulsed voltage is used for propulsion of charged particles. The principles described herein can be applied the devices in the '944 patent, as will be apparent.

A similar housing 205 may be used for alternative designs in FIGS. 3-6, but is not shown for the sake of clarity and simplicity.

FIGS. 3A-D show an electrokinetic device 300 for capturing particulates from the air in accordance with a second embodiment of the invention. The device 300 is an elaboration of the device 200, wherein instead of one pair of trapezoidal plates, there are three pairs of trapezoidal plates in a sequential arrangement. This permits the successive focusing of an initially large aperture for air entry down to successively smaller apertures. Thus, there is wire electrode 308, successive trapezoidal electrode pairs 301 and 302, 303 and 304 and 305 and 306, and the capture electrode 307.

FIGS. 4A-D show an electrokinetic device 400 for capturing particulates from the air in accordance with a third embodiment of the invention. The device 400 is similar to the device 300, again, but the sequential electrode pairs are rotated at 90° with respect to each other. It can thus be seen that if there is any tendency for charged particles to stray laterally outside of the exit aperture of an electrode pair, they will be effectively attracted back in by the configuration of the aperture of the subsequent pair. The wire electrode is 408, the first electrode pair 401 and 402, the next electrode pair rotated at 90° 403 and 404, and the subsequent pair rotate at 90° again, 405 and 406 and finally the capture electrode 407.

FIGS. 5A-C show an electrokinetic device 500 for capturing particulates from the air in accordance with a fourth embodiment of the invention. A further improvement and simplification in the geometry can result from the use of a system with radial symmetry as in FIG. 5. Here the initial high voltage wire electrode, 506, consists of two sets of parallel wires, each set being at right angles to the other, in the form of a wire mesh, and the entire array being bounded by a circle. This electrode can equally well be made of a series of wires with sharp points to generate the requisite plasma. The subsequent series of electrodes are successively smaller conic sections, 501, 502, 503, 504 and the capture electrode is a small disc, 505

FIG. 6 shows a block diagram of a control circuit 600 for controlling the device 500. With the controller the voltage differences between successive electrodes, and their timing can be separately controlled to optimize the velocity and volume of fluid flow through the system. A master controller 601 controls first through fifth controllers 602-606. Thus, the first controller 602 controls the voltage difference between the high voltage wire electrode 506 and the propulsion electrode 501. The second controller 603 controls the voltage difference between propulsion electrodes 501 and 502. The third controller 604 controls the voltage difference between propulsion electrodes 502 and 503. The fourth controller 605 controls the voltage difference between propulsion electrodes 503 and 504. Finally, the fifth controller 606 controls the voltage between propulsion electrode 504 and capture electrode 506. The Master controller 601 controls the set of controllers 602-606 to maintain synchrony to optimize a synchrotron effect. Normally, the voltages between successive sets of electrodes will be maintained at 180° out of phase, and the same peak voltage difference between successive sets of electrodes. Alternatively, it may be desirable to decrease the voltage between each successive set such that the voltage is decreased in proportion to the dimensional decrease. This will ensure that the voltage gradients in successive sections will be similar. The usefulness of alternative voltage arrangements and actual effect on ionic flow may be determined without undue experimentation. The actual frequencies of the pulses may also be tuned to maximize the ionic flow. This will be determined by the particular dimensions of the system and the flow velocity achieved by the ionized particles. Particles will be accelerated according to the Gauss principle, where the force generated is the product of the charge of a particle and the local voltage gradient.

The functionality of the control circuit of FIG. 6 can be used with any of the other devices described herein, it being understood that the number of controllers will vary dependent on the number and arrangement of the propulsion electrodes.

FIG. 7 shows a possible arrangement of the waveform of successive voltage pulses produced by the controllers 602-606 under control of the master controller 601. The first controller 602 generates a pulse A between electrodes 506 and 501 of FIGS. 5 and 6. The second controller 603 generates a pulse B between electrodes 501 and 502 of FIGS. 5 and 6. The third controller 604 generates a pulse C between electrodes 502 and 503 of FIGS. 5 and 6. The fourth controller 605 generates a pulse D between electrodes 503 and 504 of FIGS. 5 and 6. Finally, the fifth controller 606 generates a pulse E between electrodes 504 and 505 of FIGS. 5 and 6.

It can be seen that a wave of peak voltage may be caused to travel through the system of electrodes, thus creating a synchrotron effect. The timing and magnitudes of the successive sets of voltages may be optimized to maximize the ionic flow without undue experimentation.

FIG. 8 shows an alternative wave format, where square waves, or DC pulses, may be applied between successive electrodes to optimize the synchrotron effect. This is illustrated for the case of a system consisting of only a wire electrode, propulsion electrodes and capture electrode, such as in FIG. 2. Thus, A is the waveform of the voltage between the plasma-generating electrode and a propulsion electrode or set of electrodes, and B is the waveform of the voltage between the propulsion electrode or electrodes and the capture electrode.

FIG. 9 is a further elaboration of the waveforms. If the optimized frequency determined as described above for FIG. 7 is in the range of human hearing, an annoying noise might result. By using frequency modulation of the waveform, the carrier wave will have a frequency above the range of human hearing, such as is current practice for air cleaning devices. The carrier frequency is indicated in the figure by the vertical lines. A multiplicity of diverse combinations of voltage, timing, waveforms and carrier waves by frequency modulation may be chosen to optimize the performance of the synchrotron effect to maximize the volume flow and capture of the analyte of interest at the capture electrode.

In order to transport the sampled material for subjecting the sample to a bio-specific assay it is desirable to include a removable transport element. FIG. 10 illustrates an outside view of a non-conductive sleeve 700 designed to completely envelope a capture electrode, such as the electrode 203 of FIG. 2, or any of the other capture electrodes described herein. For clarity, the following description will relate to the device 200.

The sleeve 700 leaves little or no exposed surface of the capture electrode 203 in order to maximize the capture of analyte. The dimensions are in mm, and the material is cut from silk habotai, from the Dharma Trading Company, Petaluma, Calif. The dotted line 701 is a fold line and the dashed lines 702 are seam-lines. After the sleeve 700 is stitched, it is inverted so that no cut edges are on the outside. The stitching is such that there is a sufficient gap for the electrode 203 to be inserted. After enveloping with the non-conductive sleeve 700, the electrode 203 is remounted in the housing 205 and secured in place with a plastic latch.

In accordance with the teachings of the invention, the capture electrode 203 creates a potential well that will act as a trap for charged particles of interest in a flowing fluid stream and to synchronize voltage patterns to maximize the flow performance of charged particles generated. The device 200 has the capability to interpose a non-conductive material between physical contact surfaces, and to maintain voltage transmission from the use of the pulsed voltage.

### EXAMPLE

Electrodes are separated from the removable electrode assembly of the exemplary device as in the description for FIG. 10. A hot wire anemometer (Model 407123, Extech Instruments, Waltham, Mass.) is used to determine the volume flow.

TABLE 3
Volume flow from air cleaning device, modified as indicated.

| Configuration | Volume flow (L/min) |
|---|---|
| Original electrode assembly | 108 |
| Electrodes, detached from assembly and | 94 |
| re-attached with latch | |
| Same, partially covered with silk envelope, | 65 |
| allowing electrical contact | |
| Same, completely covered with silk, between | 64 |
| electrical contacts | |

Table 3 shows that, while some reduction in flow results from enclosing the electrode in a silk envelope, there is no reduction due to the interposition of the silk between the electrode contacts. The reduction in flow is a result of the capacitance of the silk envelope on the electric field gradient generated by a pulsed DC field with a frequency of about 50 KHz. In any design there will be a compromise between features that result in ease of use and the actual performance. The reduced flow from about 100 L/min to about 60 L/min still permits the sampling of a large volume of air in a air in a limited time. Thus, in a typical run of 30 minutes, about 2,000 L of air will be sampled.

It is possible to design innumerable devices within the scope of this invention, and the configuration shown in the illustrations of this document are intended to be exemplary only. Creation of a potential well provides a universal and efficient trap for charged particles and provides for seamless transfer on to a measuring or detection device. The sensitivity of the measurement of the detection or detection device is considerably enhanced by the ability to sample large volumes of fluid and to concentrate the charged particles on to a small area of a detection device. The utility of sampling and testing devices is determined by the ability to measure and detect analytes at a very low concentration. Assuming the assay method can only handle a fixed volume, the sampling efficiency is then determined by the volume flow of fluid divided by the final sampled volume. Thus, both high volume flow rate and low final sample volume are advantageous. Because the properties, disposition and dimensions of non-conducting materials do not excessively affect the voltage field distribution, there are unlimited possibilities for the design and fabrication of devices for practical applications, using, for example any of a wide range of plastic or polymeric non-conducting materials.

In consideration of the fabrication of user-friendly devices, it may be necessary or desired to interpose a layer of non-conductive capture element between an electric contact and a corresponding removable electrode. While such material would effectively insulate at the interface between the contacts in the case of a DC high voltage, in the case of a pulsed or alternating voltage, the non-conductive material would act like a capacitance and permit the transmission of the voltage across the interface.

In the devices described in the foregoing, the area of the capture electrode is small compared with other electrodes in the system, thus providing a large voltage gradient. In the examples, typical ratios of areas of capture electrodes are 20:1. Depending on the construction of the specific device, this ratio may vary in the range 5:1 to 1000:1 or even greater, limited only by the performance requirements of the specific system. The capture electrode is usually in the form of a plate, but may also take the form of a metal grid or mesh. The capture electrode may be of any suitable geometry, rectangular, square, circular, or elliptical, depending on the specific design requirements. The only constraint is that the geometry of the capture electrode may not be such as to create a potential gradient so steep as to initiate plasma generation, and generate charged particles that will be launched out of the potential well.

In the case of a multiplicity of wire electrodes for generating plasma, these are usually arrayed as parallel wires, but may also be arranged as a rectangular grid, depending on the requirements or constraints of a specific design. The wire electrodes advantageously do not exceed 1.0 mm in diameter and in one embodiment may have a diameter of approximately 0.1 mm. However, the geometry of the wires may be varied and they may also take the form of spikes with pointed tips. In this case, the pointed tip may give rise to a local potential gradient high enough to give rise to the formation of charged plasma.

The voltages applied must be sufficiently large to create the conditions for the functioning of the invention, but voltages can be varied to optimize the performance. The voltage values may be positive or negative at either the wire electrodes or the capture electrodes. For functioning, only relative voltages are important, so that any electrode may also be set at ground or low voltage, for example, for safety reasons.

For reduction to practice, the devices of the current invention can be fabricated from simple modifications of existing devices. Thus, all the specifications for details of hardware, electronic control, aesthetic considerations, dimensions, portability, power supply from ac mains or battery, are all described in detail in the prior art references given in this document, and so need no further elaboration here.

Application of the synchrotron principles elaborated herein can also be used for cleaning as well as sampling. The designs are scalable, so that extremely large volumes of air could be sampled for testing in public places where there is a risk of bioterrorism, as well as to air cleaning applications for HVAC systems and entire buildings. There would be great advantages to a whole building HVAC system with no moving parts.

Further applications to capture of entities to be assayed in dielectric media other than air can be created using the same principles as enunciated throughout this document. The dielectric fluid medium may further include non-conductive liquids, such as oils. Oils may be sampled for the presence of contaminants, contaminating organisms or bio-degrading organisms.

1. An electrokinetic device for capturing particulates from the air, comprising:
a housing enclosing a high voltage electrode, a plurality of propulsion electrodes and a capture electrode;
a control circuit electrically connected to the electrodes,
wherein, the high voltage electrode generates ionizing plasma, said plasma imparting charge on particulates from the air,
wherein said propulsion electrodes are subject to pulsed voltages in a synchronous relationship, whereby waves of voltage pulses enhance volume flow of charged substances through the device, and
wherein said capture electrode is at a low or negative voltage relative to the high voltage electrode thus creating a potential well,
whereby said particulates become electroprecipitated in said potential well.

2. The device according to claim 1 wherein said particulates comprise an analyte or analytes.

3. The device according to claim 2 further comprising a removable transport element interposed in said potential well.

4. The device according to claim 3 wherein said transport element is subject to a bio-specific assay.

5. The device according to claim 2 further comprising a biosensor interposed in said potential well.

6. The device according to claim 5 wherein said biosensor is selected from the classes of optical and electrical biosensors.

7. The device according to claim 6 wherein said optical biosensor is a surface enhanced Raman spectroscopy device.

8. The device according to claim 6 wherein said optical biosensor is a white light reflectance spectroscopy device.

9. The device according to claim 1 wherein the plurality of propulsion electrodes are configured in sets of propulsion electrodes in a sequential arrangement.

10. The device according to claim 9 wherein voltage pulses between successive sets of electrodes are synchronized such that the maximum in one set coincides with a minimum in a preceding set, so that any tendency to be attracted to the preceding set is neutralized by the potential attraction to a following set.

11. The device according to claim 9 wherein successive sets of propulsion electrodes are of progressively smaller dimensions resulting in a progressive focusing effect and progressive enhancement of flow velocity.

12. An electrokinetic device for capturing particulates from the air for bio-specific assay, comprising:
at least one wire or point high voltage electrode generating ionizing plasma, said plasma imparting charge on said particulates;
a plurality of propulsion electrodes, wherein said propulsion electrodes are subject to pulsed voltages in a synchronous relationship to control flow of particulates;
one or more capture electrodes at a low or negative voltage relative to the high voltage electrode thus creating a potential well; and
a removable sample transport means for transporting sample to said bio-specific assay, wherein said removable sample transport means is non-conductive and completely surrounds said capture electrode,
whereby electrical contact is maintained with the capture electrode by virtue of the pulsed voltage relative to high voltage electrodes.

13. The device according to claim 12 wherein the plurality of propulsion electrodes are configured in sets of propulsion electrodes in a sequential arrangement.

14. The device according to claim 13 wherein voltage pulses between successive sets of electrodes are synchronized such that the maximum in one set coincides with a minimum in a preceding set, so that any tendency to be attracted to the preceding set is neutralized by the potential attraction to a following set.

15. The device according to claim 13 wherein successive sets of propulsion electrodes are of progressively smaller dimensions resulting in a progressive focusing effect and progressive enhancement of flow velocity.

16. The device according to claim 13 wherein said propulsion electrodes comprise trapezoidal plates.

17. The device according to claim 13 wherein said high voltage electrode comprises a wire mesh.

18. The device according to claim 13 wherein said propulsion electrodes comprise successively smaller conic sections.

19. An electrokinetic device for creating fluid flow in a dielectric medium, comprising at least one wire or point high voltage electrodes generating ionizing plasma, a plurality of propulsion electrodes, wherein a succession of said propulsion electrodes are subject to pulsed voltages in a synchronous relationship, whereby waves of voltage pulses enhance volume flow of said plasma through the device, and flow of plasma imparts momentum to fluid, thus generating net fluid flow.

20. The device according to claim 19 wherein the plurality of propulsion electrodes are configured in sets of propulsion electrodes in a sequential arrangement.
